(19) United States
(12) Patent Application Publication
(10) Pub. No.: US 2010/0044430 A1
(43) Pub. Date: Feb. 25, 2010

(54) Automated Remittance Network

(76) Inventors: Yuh-shen Song, Northridge, CA (US); Catherine Lew, Northridge, CA (US); Alexander Song, Northridge, CA (US); Victoria Song, Northridge, CA (US)

Correspondence Address: FULBRIGHT AND JAWORSKI LLP, 555 S. FLOWER STREET, 41ST FLOOR, LOS ANGELES, CA, 90071, US

(21) Appl. No.: 12/611,862

(22) Filed: Nov. 3, 2009

Related U.S. Application Data
(63) Continuation-in-part of application No. 11/318,070, filed on Dec. 22, 2005, now Pat. No. 7,636,679.
(60) Provisional application No. 60/640,859, filed on Jan. 3, 2005.

(51) Int. Cl. G06Q 40/00

(52) U.S. Cl. 235/379; 705/35

(57) ABSTRACT

A computerized network empowers senders (or payers) to send funds and recipients (or payees) to receive funds at any time anywhere over the world through user-accessible terminals such as ATM terminals, check-cashing kiosks, money services kiosks, cash registers, checkout stands, computer, contactless device, wire line phone, mobile phone, smartphone, personal digital assistant, etc. Furthermore, the disclosed network collects and verifies senders' and recipients' identification information in accordance with the anti-money laundering, anti-terrorist financing, and anti-financial crimes regulatory requirements, such as the Bank Secrecy Act and the USA PATRIOT Act in the United States and any equivalent laws in other countries.

### CROSS REFERENCE TO RELATED APPLICATION

This application is a continuation-in-part of prior U.S. patent application Ser. No. 11/318,070, to Song et al., filed Dec. 22, 2005, which claims the benefit of U.S. Provisional Application No. 60/640,859, to Song et al., filed Jan. 3, 2005, the disclosures of which are expressly incorporated by reference herein in their entireties.

### FIELD OF INVENTION

The present disclosure relates generally to conducting remittance or payment transactions through networked user-accessible terminals. More specifically, the present invention provides a method and apparatus to effect a computerized transfer of funds from a sender (or payer) at a first terminal, to a recipient (or payee) at a second terminal possibly in another country or region, while providing any involved organizations with verified identification information of both the sender (payer) and the recipient (or payee).

### BACKGROUND OF THE INVENTION

People have many reasons to send money from one location to another. For example, as a result of globalization, people often work at a place far away from home, possibly even in a different country. They often have to send money back to their hometowns in order to support their families or relatives.

The traditional approach of sending money is to use a wire transfer, which requires the recipient to have a bank account. Unfortunately, banking systems are not popular with the general population in many parts of the world and thus many prospective recipients do not have any bank accounts.

To meet this huge market need, Western Union, MoneyGram and many other financial institutions have established branches and agents all over the world. The sender gives money to one of the branches or agents in the sender's area and then the recipient will receive money from one of the branches or agents in the recipient's location area after a proper identification process. Billions of dollars are moving around the world this way every year.

The cost of doing this business is very high because it is a labor intensive process. Most countries have imposed anti-money laundering, anti-terrorist financing, and anti-financial crimes obligations upon financial institutions. These financial institutions have to, for example, (1) verify and record the sender's and recipient's identification information, (2) check the sender and recipient against the “blacklists” published by various governments before completing the transaction, and (3) detect any suspicious activity and report it to the government agencies.

These branches and agents of financial institutions are dependent on manual processing to complete the transaction and to fulfill the anti-money laundering, anti-terrorist financing, and anti-financial crimes requirements imposed by the governments. Furthermore, the branches and agents of the financial institutions are not available everywhere at all times. A sender or a recipient may have to travel a long distance to complete the transaction during the business hours. In case of emergency, there is not much that the sender or the recipient can do to speed up the process.

Governments worldwide are requiring financial institutions to verify and collect at least certain text-based identification information associated with each of the parties to financial transactions in order to enforce anti-money laundering, anti-terrorist financing, and anti-financial crimes laws.

There is thus a need for an automated remittance transaction process which can be automatically performed by user-accessible terminals, 24 hours a day, 7 days a week, and which can be made available almost anywhere in the world.

It has been proposed to conduct remote transactions through ATM terminals using a physical “convenience card” which has been purchased from a vending machine. Such a “convenience card” may then be used to open an account with a sponsoring financial institution before conducting transactions based on this card; however, the “convenience card” does not necessarily identify who the owner of the newly opened account really is; moreover, once the account has been opened, that same “convenience card” can be stolen by or otherwise come into the possession of a criminal or terrorist who can then use the card to send money all over the world to another criminal or terrorist.

With modern technologies, government authorities can store a great deal of machine-readable personal identification information within a person's official identification document such as passport, national identification card, voter card, driver's license, etc. For example, the stored identification information may include biometrical information such as a fingerprint, an iris pattern, a picture, etc., that identifies a particular individual.

In addition, those same government authorities can store conventional text-based identification information associated with that same individual such as the name, date of birth, identification number, social security number and/or address within the same official identification document, in a manner that assures that the stored text-based information is properly associated with the same individual as the stored biometrical information.

In this document, the terminology “network” or “networks” generally refers to a communication network or networks, which can be wireless or wired, private or public, or a combination of them, and includes the well-known Internet.

In this document, the terminology “computer” or “computer system” generally refers to either one computer or a group of computers, which may work alone or work together to accomplish the purposes of the system.

In this document, the terminology “computer network” generally refers to either one network or a group of connected networks, which may work alone or work together to accomplish the purposes of the network.

In this document, a “bank” or “financial institution” is generally referred to as a “financial service provider”, which encompasses either a bank or a non-bank where financial services are provided.

In this document, a “bank account” or “financial account” is generally referred to as an “account in a financial institution”, and encompasses accounts in either a bank or a non-bank where financial transactions are conducted by means of payment instruments such as cash, checks, credit cards, debit cards, ATM cards, stored-value cards, gift cards, wires, monetary instruments, electronic fund transfers, automatic clearing house, etc.

In this document, the terminology “terminal” or “kiosk” generally refers to equipment, including a computer and/or its peripherals, microprocessor and/or its peripherals, ATM terminal, check-cashing kiosk, money services kiosk, merchant checkout stand, cash register, coin exchange machine, parking lot payment kiosk, other payment kiosks, contactless device, wire line phone, mobile phone, smartphone, PDA, digital assistant, entertainment device, network interface device, router, and/or Personal Digital Assistant (PDA), etc., which interfaces a user with a computer network, so that the user may interact with computer systems and other equipment connected to the computer network.

In this document, the terminology “official identification document” generally refers to a passport, a driver's license, a voter card, a benefits card, a national identification card, an identity card, a certificate of legal status, and other official documents and information bearing instruments that identify a designated individual by certain verifiable characteristics, that are issued or certified by a consulate, embassy, government agency, or other governmental authorities, and that are protected against unauthorized copying or alteration by the responsible government. In particular, such “official identification documents” can be formed from various materials, including paper, plastic, polycarbonate, PVC, ABS, PET, Teslin, composites, etc. and can embed the identification information in various formats, including printed or embossed on the document (or card), written on a magnetic medium, programmed into an electronic device, stored in a memory, and combinations thereof. The “identification information” may include, but is not necessarily limited to, names, numbers, date of birth, signatures, addresses, passwords, personal identification numbers, tax identification numbers, national identification numbers, countries that issue the IDs, states that issue the IDs, ID expiration date, photographs, fingerprints, iris scans, physical descriptions, and other biometric information. The embedded information can be read through optical, acoustic, electronic, magnetic, electromagnetic and other media.

In this document, the role of a “sender” in a remittance transaction generally applies to the role of a “payer” in a payment transaction. The role of a “recipient” in a remittance transaction generally applies to the role of a “payee” in a payment transaction. A “remittance” transaction can also be generally referred to as a “payment” transaction.

### SUMMARY OF THE INVENTION

One objective of the present invention is to automate the process of remittance transactions using terminals (which in certain embodiments may be located anywhere in the world). Instead of going to financial institutions to conduct remittance transactions, senders and recipients can conduct these transactions at any participating user-accessible terminals, such as ATM terminals, check-cashing kiosks, money services kiosks, merchant checkout stands, cash registers, coin exchange machine, parking lot payment kiosks, other payment kiosks, computers, contactless device, wire line phones, mobile phone, smartphone, PDA, digital assistants, entertainment devices, network interface devices, routers, etc.

Another objective is to remove the traditional need for senders and recipients to appear at a financial institution in person to open an account while at the same time assuring compliance with applicable anti-money laundering, anti-terrorist financing and anti-financial crimes requirements imposed by governments all over the world. Furthermore, a payer can conduct payment transactions for point-of-sale, remote or online transactions without using the traditional payment instruments such as cash, checks, credit cards, debit cards, ATM cards, stored-value cards, gift cards, wires, monetary instruments, electronic fund transfers, automatic clearing house, etc. In this document, although remittance transactions are often used as examples, the present disclosure also applies to payment transactions.

By reading the embedded information from an official identification document, a user-accessible terminal can verify the true identity of a person. For example, a user-accessible terminal can directly read the fingerprint information of a person. If the scanned fingerprint of a person matches the fingerprint information embedded within an official identification document, this person must be the official owner of this official identification document. Alternatively, for example, if a person can correctly enter a correct piece of private information such as personal identification number, etc. associated with the official identification document, this person can be authenticated as the owner of this official identification document. As a result, the text-based identification information embedded within and on the official identification document such as name, date of birth, address, social security number, ID number, issuing authority, etc. has been verified and can be used as a token for the identity of that same person.

In one embodiment of the present invention, after verifying the true identity of a sender, a user-accessible terminal may prompt the sender to deposit funds into the Automated Remittance Network (“ARN”) for effecting a remittance transaction by means of cash, checks, electronic fund transfers, automatic clearing house, credit cards, debit cards, ATM cards, stored-value cards, gifts cards, wires, or monetary instruments, and combinations thereof, or direct funds transfers from at least (1) one of the sender's financial accounts including checking, saving, trust, brokerage, insurance, credit card, debit card, ATM, stored-value, payment, money services, etc., (2) one of the third parties' accounts, or (3) one of the accounts of the ARN computer.

The user-accessible terminal may then prompt the sender to provide at least minimal identification information of the recipient. In addition, a Transaction Identification Number (“TIN”) may be issued by the ARN computer system to identify this transaction. The TIN, the transactional details, and the sender's and the recipient's identification information are preferably stored securely within a transactional database of the ARN computer system. The ARN computer system preferably also performs anti-money laundering, anti-terrorist financing, and anti-financial crimes measures according to the laws of the local governments worldwide.

In some embodiments, the sender can give the TIN to the recipient by means of telephonic, e-mail or other communication methods. To leverage on the existing infrastructure, a user-accessible terminal can be integrated as part of an ATM terminal, check-cashing kiosk, money services kiosk, cash register, checkout stand, parking lot payment kiosk, other payment kiosk, coin exchange machine, computer, contactless device, wire line phone, mobile phone, smartphone, PDA, digital assistant, entertainment device, network device, or other type of money-transactional terminals. The ARN can be integrated with the existing ATM network, credit card or debit card network, Internet, ACH network, SWIFT network, phone network, data network, wire transfer network or other type of private or public network having a level of security suitable for processing financial transactions. As a result, the recipient can go to any participating ATM terminal, check-cashing kiosk, money services kiosk, cash register, checkout stand, parking lot payment kiosk, other payment kiosk, coin exchange machine, computer, contactless device, wire line phone, mobile phone, smartphone, PDA, digital assistant, entertainment device, or other money-transactional terminals to receive funds based on the commercial arrangements between the ARN and the owners of these networks and/or of the connected user-accessible terminals.

After verifying the identity of a claimant using the embedded information of the claimant's official identification document, a second user-accessible terminal preferably prompts the claimant to enter the previously assigned TIN. The ARN computer can perform additional anti-money laundering, anti-terrorist financing, and anti-financial crimes measures based on the additional information provided by the recipient. Based on this TIN, the ARN computer system may then search its database and locate the transactional details and the recipient's identification information provided by the sender. If the intended recipient's identification information, which has been provided by the sender to the ARN, corresponds to the claimant's embedded identification information, which is stored within or on the claimant's official identification document, the identity of both the sender and the recipient have been properly verified and the user-accessible terminal may then issue the payment to the recipient by means of cash, checks, electronic fund transfers, automatic clearing house, credit cards, debit cards, ATM cards, stored-value cards, gift cards, wires, or monetary instruments, and combinations thereof, or direct funds transfers to at least (1) one of the recipient's financial accounts including checking, saving, trust, brokerage, insurance, credit card, debit card, ATM, stored-value card, gift card, payment, money services, etc., (2) one of the third parties' accounts, or (3) one of the accounts of the ARN computer.

Some embodiments can be used by a group of organizations. A common computer system and transactional database may handle all the remittance transactions for these organizations by sharing the same network of user-accessible terminals. Alternatively, each organization may have its own computer system and transactional database to conduct all the remittance transactions originated from those user-accessible terminals, which are managed by the organization.

In certain embodiments, by using a TIN that identifies the organization or transaction network that has accepted the funds on behalf of the sender, a network switch can readily route a recipient's request for payment to that particular organization or transaction network to complete the remittance transaction.

### BRIEF DESCRIPTION OF THE FIGURES

FIG. 1 illustrates the system and network diagram of an exemplary Automated Remittance Network (“ARN”), which enables a sender from anywhere in the world to send money to a recipient anywhere in the world at any time.

FIG. 2A-D are flow charts indicating an exemplary manner in which the system and network shown in FIG. 1 automates the remittance transactions.

### DETAILED DESCRIPTION

Although we contemplate that the present invention will in practice be used in many different environments and will be manifested in numerous embodiments, we will describe in detail only a few exemplary presently preferred embodiments of the present invention and certain exemplary combinations of those embodiments.

The Automated Remittance Network (“ARN”) is established on a computer network, which may preferably connect many user-accessible terminals, such as ATM terminals, check-cashing kiosks, money services kiosks, checkout stands, cash registers, coin-exchange kiosks, payment kiosks, computers, contactless devices, wire line phones, mobile phones, smartphones, personal digital assistants, other digital assistants, entertainment devices, network devices, and other money-transactional terminals. An ARN computer system is preferably provided for processing the transactions, managing accounts, controlling the data exchange, keeping the records, and managing the activities occurring on the ARN.

When a sender (or payer) intends to transfer funds, the ARN verifies his/her identity in order to comply with the requirements of any relevant anti-money laundering, anti-terrorist financing, and anti-financial crimes set by the governments.

In one embodiment of the present invention, the user-accessible terminal reads the embedded identification information of the sender's official identification document such as passport, voter card, national identification card, driver's license, government-issued official identification document, etc. The embedded information may include text-based information such as name, address, date of birth, ID number, ID expiration date, ID issuing authority, ID issuing country, ID issuing state, personal identification number, password, and tax ID, and digitized image-based information such as signature, fingerprint, voice pattern, iris pattern, and facial pattern, etc. The embedded identification information can be read through an electronic media, optical media, acoustic media, magnetic media, electromagnetic media including radio frequency signals, other media or any combination.

In addition, the user-accessible terminal scans or otherwise obtains directly from the sender, a set of personal information or a set of partial personal information, such as personal identification number, password, tax identification number, last four digits of tax ID, private personal information, and biometric information including digitized personal identification image-based information such as a fingerprint, a voice pattern, an iris pattern, a facial pattern, etc.

The user-accessible terminal authenticates the sender's identity by comparing the personal information input by the sender with the information embedded within or on the official identification document or the information associated with the embedded information. For example, if the fingerprint of the sender matches the fingerprint information embedded within or on the official identification document, the sender must be the official owner of the official identification document. If the social security number submitted by the sender matches the social security number associated with the official identification document, the sender is the official owner of the official identification document. Consequently, the user-accessible terminal can obtain the sender's verified name, address, date of birth, ID number, ID expiration date, ID issuing authority, and any other required information from the sender's official identification document and send that information to the ARN computer system.

Alternatively, in another embodiment of the present invention, the sender's embedded identification information can be sent to the ARN computer and the authentication can be done by the ARN computer. In certain jurisdictions or countries, a person's identity must match the official identification document he/she carries. Sometimes, the regulation does not require money transmitters to authenticate a sender based on an official identification document. Under such circumstances, the mere submission of an official identification document by a sender is sufficient for authentication purposes.

In another embodiment of the present invention, a human operator interfaces with the sender, verifies the identification of the sender, and uses a computer terminal or equivalent equipment to perform other equivalent functions, which the above user-accessible terminal would perform.

In one embodiment of the present invention, the identification information reading and/or identity authentication device (or capability) described above is incorporated into or attached to equipment such as a computer, contactless device, wire line phone, mobile phone, smartphone, PDA, digital assistant, entertainment device, network device, etc. so that a sender can conduct the remittance transaction with the equipment.

After thus verifying the identity of the sender, the user-accessible terminal will prompt the sender to provide at least certain minimal recipient identification information such as legal name, the official identification document number, last six digits of the official identification number, date of birth, ID issuing authority, etc. Then, the sender can deposit funds into the ARN.

In one embodiment of the present invention, the sender deposits cash into the user-accessible terminal or to a human operator of the terminal. In another embodiment of the present invention, the sender deposits funds by means of check, monetary instrument, wire, credit card, debit card, ATM card, stored-value card, or other financial instruments. In an alternative embodiment of the present invention, the sender gives instructions to transfer funds from one of his/her financial accounts to fund the remittance transaction. In yet another alternative embodiment of the present invention, a third party may fund the remittance transaction through a commercial arrangement with the sender. Alternatively, the sender can transfer funds from an account associated with the ARN.

Once the funds have been received, in one embodiment of the present invention, the ARN computer system will issue a TIN for the sender to keep as his/her record. At the same time, the computer system of ARN stores the TIN, transactional details, the sender's identification information and the sender-supplied recipient identification information into a database. The sender can then inform the recipient (or payee) of the TIN by any conventional means (such as mail, email, instant message, text message, voicemail, telephone, etc).

Alternatively, in another embodiment of the present invention, the ARN computer system will issue a TIN for the sender to keep after the funds have been received by the ARN even if the authentication of the sender has not been completed yet. This situation is possible when a complicated authentication process is used.

In one embodiment of the present invention, once in possession of the TIN, the recipient (or claimant) can go to any participating user-accessible terminal, which connects to ARN. The user-accessible terminal reads the embedded identification information of the claimant's official identification document, such as passport, driver's license, government-issued ID, etc. After verifying the identity of the claimant, the user-accessible terminal prompts the claimant to provide the TIN, which is used to identify the transaction. The verified identification information and the TIN are then sent to the computer system of ARN. Alternatively, the claimant can enter the TIN first and then submit his/her identification document. Furthermore, the claimant's embedded identification information can be sent to the ARN computer and the verification can be done by the ARN computer. In certain jurisdictions or countries, the mere submission of an official identification document by a claimant is good for verification purposes.

The ARN computer system uses the TIN to locate the record, from which the sender's identification information, the sender-supplied recipient identification information, the transactional details and other relevant information may be extracted.

The ARN computer system then verifies whether the extracted recipient identification information that had been provided by the sender corresponds to the official identification information provided by the claimant.

If the verification is successful, the computer system of ARN approves the delivery of the payment to the claimant as instructed by the sender. If the verification fails, the computer system of ARN informs the user-accessible terminal to reject the transaction.

Sometimes, it is not necessary to have an exact match between the claimant identification information and the recipient identification in order for the ARN computer to approve the delivery of payment to the claimant. For example, the sender may enter the word “Alex” as the first name of the recipient while the official first name of the claimant is “Alexander.” The delivery of payment can still be approved by the ARN computer as long as, based on the best judgment of the ARN computer, the claimant identification information “corresponds to” the recipient identification information supplied by the sender.

In one embodiment, the payment is issued in the form of cash. In another embodiment of the present invention, the payment is issued by means of a stored-value card, credit card, debit card, gift card, mobile wallet device, smart chip, contactless device, monetary instrument, or a check. In yet another alternative embodiment, the payment is issued by transferring funds into one of the recipient's financial accounts including but not limited to checking, savings, certified deposits, trust, brokerage, insurance, ATM card, payment services, money services, stored-valued card, gift card, credit card or debit card accounts, accounts with the ARN computer system, or into third-party accounts as specified by the claimant.

In one embodiment, a computer system and database are used by a single organization to perform all the transactions and to direct all the remittance activities for all the user-accessible terminals of the ARN. In another embodiment of the present invention, each participating organization or a group of participating organizations may use a computer system and database to perform all the transactions and direct all the remittance activities for those user-accessible terminals which are managed by the organization or the group of organizations.

The final settlement will be completed between the organization, which has accepted funds on the sender's behalf, and the organization, which has delivered the funds on the recipient's behalf, according to the convention of the industry. Since the ARN computer system in either embodiment contains the detailed information of both sender and recipient, it can perform anti-money laundering, anti-terrorist financing, and anti-financial crimes procedure as required by the government.

In one embodiment of the present invention, the ARN is integrated with the existing ATM network. In another embodiment of the present invention, the ARN is integrated with the existing credit card or debit card network. In an alternative embodiment of the present invention, the ARN is integrated with the existing Automatic Clearing House (“ACH”) network. In another alternative embodiment of the present invention, the ARN is integrated with other real-time or non-real time networks, including the Internet, phone networks, data networks, etc.

In some presently preferred embodiments, the TIN may incorporate the identification information of an organization (or computer system) holding the funds on behalf of the sender. An included ARN network switch can then use that incorporated organization (or computer system) identification information to direct the recipient's request of payment to the involved organization (or computer system), to complete the remittance transaction.

In one embodiment, after authenticating the identity of a person, the user-accessible terminal can prompt the person to open an account with a computer system of the ARN and the personal identification information is stored in the database of the ARN.

In another embodiment, a person or an organization can open an account with a computer system of ARN based on the conventional account opening process used in the industry. For example, a person or an organization can submit application forms either in person or remotely and request the computer system of ARN to approve the opening of an account.

An account holder can use his/her official identification document to identify the account. The account can keep funds like a traditional financial account. In one embodiment, the account can be funded with check, monetary instrument, wire, credit card, debit card, gift card, ATM card, stored-value card, or other financial instruments. In another embodiment, the account holder gives instructions to transfer funds from one of his/her other financial accounts to fund the account. In yet another embodiment, a third party may fund the account through a commercial arrangement with the account holder.

The funds can be transferred out from the account to other financial accounts of either the account holder or third parties. These financial accounts include, but are not limited to, checking, savings, certified deposit, trust, brokerage, insurance, ATM card, payment services, money services, stored-valued card, credit card or debit card, gift card accounts, or accounts with the ARN computer system.

As a result, after the account is opened, a person can use the traditional approach (for example, entering user ID and password) to log into the computer of the ARN and conduct remittance transactions on the ARN, as either a sender or a recipient. The person can conduct the transaction from a terminal such as a computer, ATM, checkout stand, payment kiosk, contactless device, wire line phone, mobile phone, smartphone, PDA, digital assistant, etc. which connects to the computer system of the ARN via a network, such as the Internet, phone network, data network, etc.

In yet another embodiment, after the account is opened, a person can use his/her official identification document to identify his/her account and conduct financial transactions, including payment transactions for any good or services, through a user-accessible terminal connected to the computer system of ARN. The payments are settled based on the commercial arrangements between the computer system of the ARN and the merchants or the respective organizations. As a result, an account holder of an ARN computer system can purchase goods and services by using an official identification document without the need to use the traditional payment instruments, such as cash, checks, wires, monetary instruments, credit cards, debit cards, ATM cards, stored-value cards, gift cards, etc.

In yet another alternative embodiment, an account holder of the ARN computer system can electronically transfer funds to another account holder of the ARN computer system by using a terminal such as a computer, ATM, checkout stand, payment kiosk, contactless device, wire line phone, mobile phone, smartphone, PDA, digital assistant, etc. which connects to the computer system of the ARN via a network, such as the Internet, phone network, data network, etc. As a result, the ARN computer system can also be used as a payment system for both online transactions and point-of-sale transactions.

In one embodiment of the present disclosure, an account holder of the ARN computer system can use his/her official identification document to identify his/her account and withdraw cash from a terminal, e.g., an ATM, which connects to the ARN computer.

In another embodiment of the present disclosure, an account holder of the ARN computer system can use his/her user ID and password to identify his/her account and withdraw cash from a terminal, e.g., an ATM, which connects to the ARN computer.

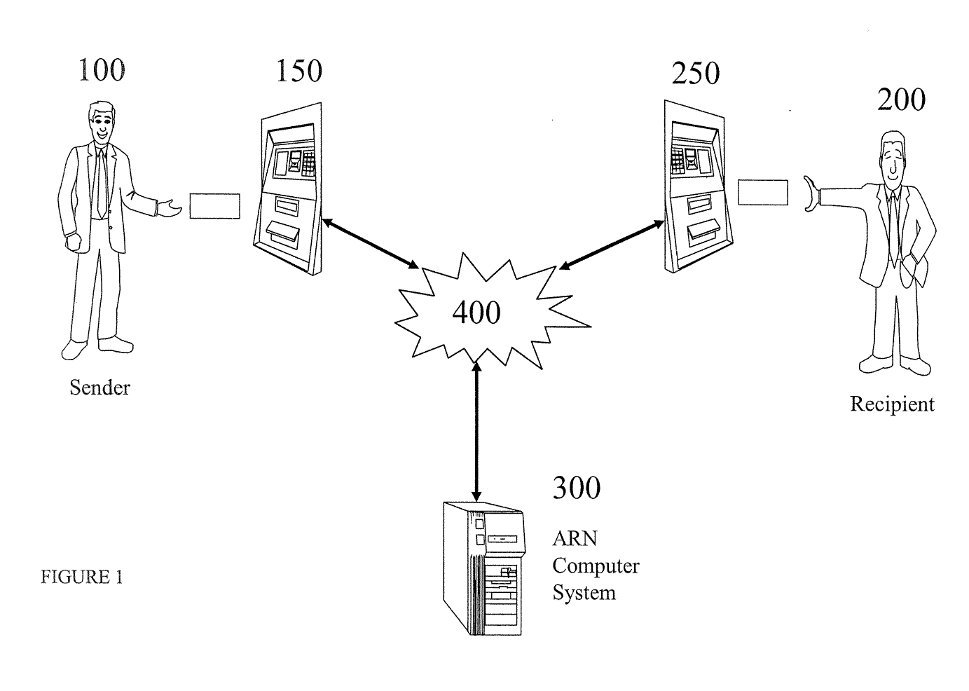

As contemplated in the described embodiments, one of the possible combinations of the preferred embodiments is given below as an example. The Computer System 300 of the ARN enables the sender 100 to send funds to a recipient 200 through ATM terminals 150 and 250, respectively, which connects to a network 400 as shown in FIG. 1.

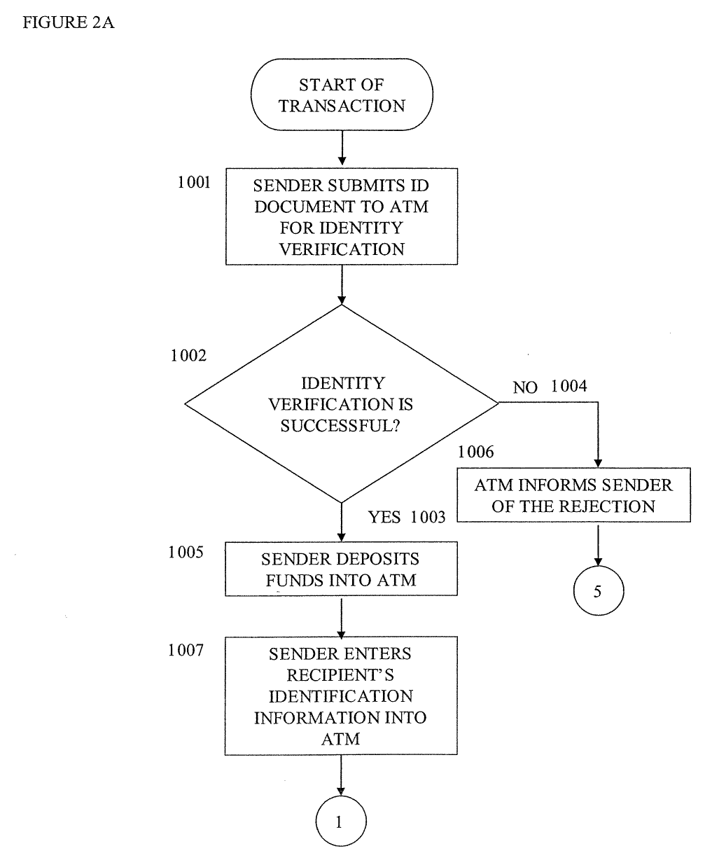

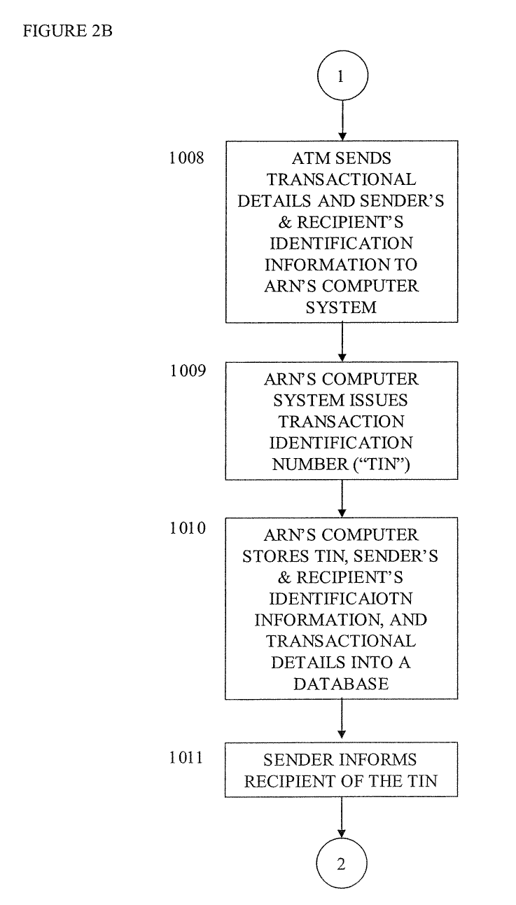

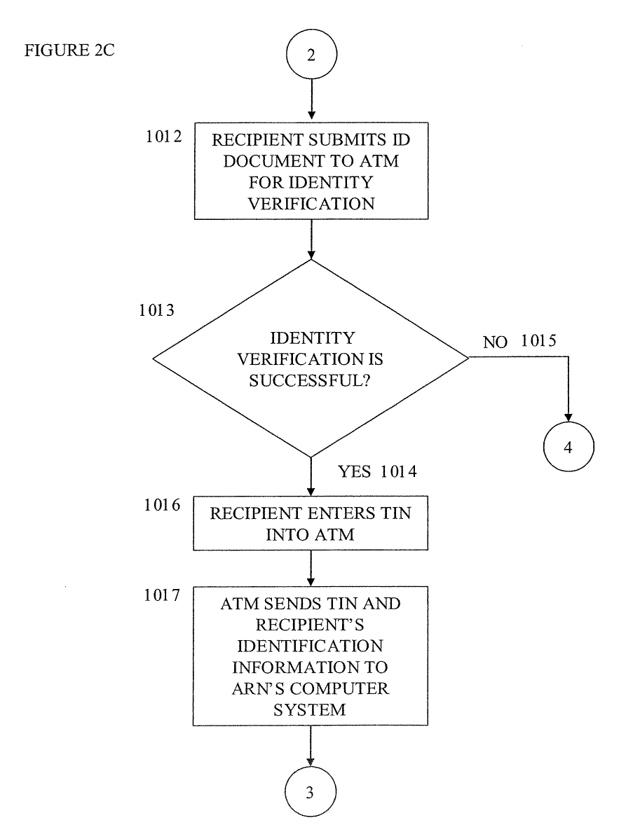

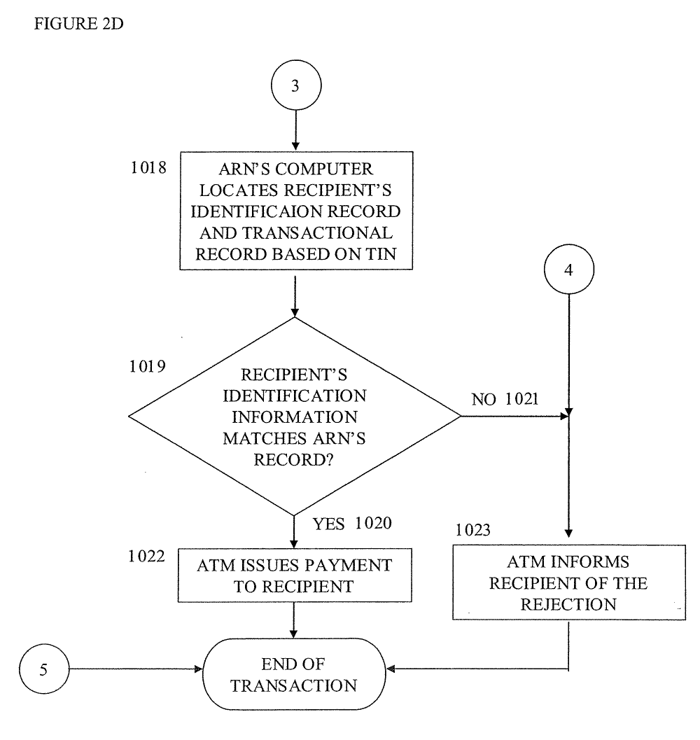

References should now be made to the flowchart of FIG. 2 in combination with the system diagram of FIG. 1, which together illustrate how the system enables a sender to send money to a recipient through the ARN.

First (block 1001), a sender 100 submits a passport or other official identification document to an ATM terminal 150, which can read the embedded identification information of the official identification document. The ATM terminal 150 also reads the personal identity information, such as a fingerprint, directly from the sender 100.

Then (decision block 1002), the ATM terminal 150 verifies the sender's personal identity information, such as a fingerprint, with the identification information embedded within the official identification document of the sender 100.

If the identity of the sender 100 cannot be verified (NO branch 1004), the ATM 150 informs the sender 100 of the rejection (block 1006). This action subsequently ends the transaction.

If the identity of the sender 100 is verified successfully (YES branch 1003), the sender 100 will deposit funds into the ATM terminal 150 (block 1005).

In addition (block 1007), the sender 100 enters the identification information of the recipient 200 into the ATM terminal 150.

After collecting the information from the sender (block 1008), the ATM 150 sends the transactional details, the sender's identification information and recipient's identification information to the computer system 300 of the ARN via a network 400.

Subsequently (block 1009), the computer system 300 of ARN issues a TIN to identify this specific transaction.

Furthermore (block 1010), the computer system 300 of ARN stores the TIN, the transactional details, the sender's identification information, and the recipient's identification information into a database.

For the recipient 200 to receive the funds, the sender 100 has to inform the recipient 200 of the TIN, which has the dual effects of transaction identification and security protection (block 1011).

After obtaining the TIN (block 1012), the recipient 200 submits his/her passport or other official identification document to the ATM terminal 250 for identity verification.

The ATM terminal 250 verifies the personal identity information of the recipient 200, such as a fingerprint, with the identification information embedded within the official identification document (decision block 1013).

If the ATM terminal 250 cannot verify the identity of the recipient 200 (NO branch 1015), the ATM terminal 250 informs the recipient 200 of the rejection and ends the transaction.

If the identity verification is successful (YES branch 1014), the recipient 200 can enter TIN into the ATM terminal 250 (block 1016).

After receiving the TIN (block 1017), the ATM terminal 250 sends TIN and recipient's identification information to the computer system 300 of ARN via a network 400.

Based on the TIN (block 1018), the computer system 300 of ARN locates the records of the transactional details and the recipient's identification information entered by the sender 100.

The computer system 300 of ARN verifies the recipient's identification information, which is read by the ATM terminal 250, with the recipient's identification information in the record, which is entered by the sender 100 (decision block 1019)

If it does not match (NO branch 1021), the ATM 250 informs the recipient 200 of the rejection (block 1023).

If it is a match (YES branch 1020), the ATM terminal 250 issues a payment to the recipient 200 based on the instruction given by the sender 100 (block 1022).

This remittance transaction is completed via the ATM terminals 150 and 250, which can be located anywhere around the world.

In this process, the transactional details and identification information of the sender 100 and the recipient 200 are collected in accordance with governments' regulations for the purposes of anti-money laundering, anti-terrorist financing, and anti-financial crimes.

This invention can be used by a group of organizations. A common computer system and database can handle all the remittance transactions for these organizations by sharing the same network of user-accessible terminals. Alternatively, each organization can have its own computer system and database to conduct all the remittance transactions originated from those user-accessible terminals, which are managed by the organization.

By using a TIN that includes the identification information of the particular terminal, organization, shared computer system or other network node which has accepted the sender's funds, a network switch can route a recipient's request for payment to that particular node, computer system, organization, etc. to complete the remittance transaction.

Even though the sender or recipient may not be associated with any account in any financial institution, by requiring that the sender and recipient each use an official identification document, and by appropriate use of the information stored in those documents or instruments to complete the transaction in accordance with the present invention, it is thus possible for such a transaction to be fully compliant with the regulatory requirements of the Bank Secrecy Act, the USA PATRIOT Act and other equivalent laws. As an additional protection, video cameras can record the activities in the vicinity of the terminals for the purposes of crime prevention.

Those skilled in the art will recognize that the described embodiments can be assembled in various ways to form a variety of applications based on the need, and that obvious alterations and changes in the described structure may be practiced without meaningfully departing from the principles, spirit and scope of this invention. Accordingly, such alterations and changes should not be construed as substantial deviations from the present invention as set forth in the appended claims.

What is claimed:

1. A method for performing a fund transfer transaction from a sender to a recipient through a computerized network of user-accessible terminals, comprising:
receiving first embedded identification information from a first official identification document submitted by the sender, the first embedded identification information, which is used to identify the sender, including an official identification document number, and at least one of a country and state that issued the official identification document;
receiving recipient identification information and other transactional details for the fund transfer transaction from the sender;
storing a transaction identification number, a sender identity, the recipient identification information and the other transactional details, the transaction identification number including an identification of a computer system that assigned the transaction identification number;
receiving second embedded identification information, which is used to verify an identity of a claimant, from a second official identification document submitted by the claimant;
receiving the transaction identification number from the claimant;
retrieving the recipient identification information and the other transactional details associated with the transaction identification number received from the claimant; and
authorizing delivery of payment to the claimant in accordance with the retrieved transactional details when the second embedded identification information corresponds to the retrieved recipient identification information associated with the transaction identification number,
whereby the sender and the recipient on different networks can complete the fund transfer transaction using the transaction identification number that identifies the computer system.

2. The method of claim 1 in which the storing of the sender's identity further comprises storing at least one of a name, date of birth, address, tax identification number, personal identification number, national identification number, password, type of official identification document, official identification document number, country that issued the official identification document, state that issued the official identification document, expiration date of the official identification document, signature, photograph, fingerprint, iris scan, physical description, and other biometric information.

3. The method of claim 1 further comprising:
performing at least one of anti-money laundering, anti-terrorist financing and anti-financial crimes measures based on a government having jurisdiction over the sender.

4. The method of claim 1 further comprising:
performing at least one of anti-money laundering, anti-terrorist financing and anti-financial crimes measures based on a government having jurisdiction over the recipient.

5. The method of claim 1 further comprising:
permitting the sender to open an account after authenticating the identity of the sender, the authenticated identification information of the sender being stored with the account.

6. The method of claim 5 further comprising:
permitting the sender to conduct at least one future fund transfer transaction and receive a future transaction identification number by logging into the account with at least one of a user ID, personal identification number, and password and without any official identification document.

7. The method of claim 5 further comprising:
permitting the sender to identify the account with any official identification document of the sender.

8. The method of claim 5 further comprising:
permitting the sender to transfer money into the account.

9. The method of claim 5 further comprising:
permitting the sender to transfer money out of the account.

10. The method of claim 5 further comprising:
permitting the sender to conduct at least one payment transaction based on the account with any official identification document of the sender to identify the account at a terminal that connects to the computer system.

11. The method of claim 1 further comprising:
permitting the claimant to open an account after authenticating the identity of the claimant, the authenticated identification information of the claimant being stored with the account.

12. The method of claim 11 further comprising:
permitting the claimant to receive at least one future payment identified by a future transaction identification number by logging into the account with at least one of a user ID, personal identification number, and password and without any official identification document.

13. The method of claim 11 further comprising:
permitting the claimant to identify the account with any official identification document of the claimant.

14. The method of claim 11 further comprising:
permitting the claimant to transfer money into the account.

15. The method of claim 11 further comprising:
permitting the claimant to transfer money out of the account.

16. The method of claim 11 further comprising:
permitting the claimant to conduct at least one payment transaction based on the account with any official identification document of the claimant to identify the account at a terminal that connects to the computer system.

17. A method for performing a fund transfer transaction from a sender to a recipient through a computerized network of user-accessible terminals, comprising:
receiving embedded identification information from an official identification document submitted by the sender, the embedded identification information, which is used to identify the sender, including an official identification document number, and at least one of a country and state that issued the official identification document;
receiving recipient identification information and other transactional details for the fund transfer transaction from the sender;
storing a transaction identification number, a sender identity, the recipient identification information and the other transactional details, the transaction identification number including an identification of a computer system that assigned the transaction identification number; and
authorizing delivery of payment to a claimant in accordance with the other transactional details when claimant identification information corresponds to the recipient identification information associated with the transaction identification number,
whereby the sender and the recipient on different networks can complete the fund transfer transaction using the transaction identification number that identifies the computer system.

18. A method for performing a fund transfer transaction from a sender to a recipient through a computerized network of user-accessible terminals, comprising:
receiving second embedded identification information, which is used to verify an identity of a claimant, from an official identification document submitted by the claimant;
receiving a transaction identification number from the claimant, the transaction identification number including an identification of a computer system that assigned the transaction identification number and stored the transaction identification number, recipient identification information, other transactional details defined by the sender and a sender identity obtained from first embedded identification information of an official identification document submitted by the sender, the first embedded identification information including an official identification document number, and at least one of a country and state that issued the official identification document; and
receiving authorization of delivery of payment to the claimant in accordance with the other transactional details when claimant identification information corresponds to the recipient identification information associated with the transaction identification number,
whereby the sender and the recipient on different networks can complete the fund transfer transaction using the transaction identification number that identifies the computer system.

19. A computerized network for performing a fund transfer transaction from a sender to a recipient, comprising:
a first terminal connected to the network and accessible to the sender, the first terminal including:
a first reader that reads first embedded identification information from a first official identification document submitted by the sender, the first embedded identification information, which is used to identify the sender, including an official identification document number, and at least one of a country and state that issued the official identification document, and
a first user input device that receives recipient identification information and other transactional details for the fund transfer transaction;
a computer system connected to the network for assigning a transaction identification number to the fund transfer transaction and for storing into a database the transaction identification number, sender identity information, the recipient identification information and the other transactional details, the transaction identification number including an identification of the computer system; and
a second terminal connected to the network and accessible to a claimant, the second terminal including:
a second reader that reads second embedded identification information, which is used to verify an identity of the claimant, from a second official identification document submitted by the claimant, and
a second user input device that receives the assigned transaction identification number from the claimant;
wherein the computer system uses the transaction identification number provided by the claimant to retrieve the recipient identification information and the other transactional details associated with the transaction identification number, and authorizes delivery of payment to the claimant in accordance with the retrieved transactional details when claimant identification information corresponds to the retrieved recipient identification information.

20. The network of claim 19 in which the computer system comprises at least a first computer and a second computer, the network further comprising:
at least one network switch to connect a first sub-network incorporating a first plurality of user accessible terminals and the first computer to a second sub-network incorporating a second plurality of user-accessible terminals and the second computer, the first terminal being directly connected to the first sub-network, and the second terminal being directly connected to the second sub-network.

21. The network of claim 20 in which each transaction identification number assigned by a respective computer identifies the respective sub-network associated with the computer; and the network switch uses the transaction identification number input by the claimant to route a payment request from the second terminal to the first computer; whereby the sender and the recipient on different networks can complete the fund transfer transaction using the transaction identification number that identifies the computer responsible for the transaction initiated by the sender.

22. The network of claim 20 in which at least one of the sub-networks is adapted to process fund transfer transactions between terminals directly connected to the at least one sub-network.

23. The network of claim 20 in which each computer includes a database comprising:
a reconciliation system that reconciles accounting records for a completed fund transfer transaction between the first computer and the second computer, and
a settlement system that settles the payment between the first computer and the second computer.

24. The network of claim 19 in which at least one of the first terminal and the second terminal comprises a user-accessible terminal integrated with a terminal selected from the group consisting essentially of a computer, wire line telephone, mobile phone, personal digital assistant, entertainment equipment, network device, contactless device, ATM terminal, service representative terminal, check-cashing kiosk, money services kiosk, payment kiosk, coin-exchange machine, cashier register, and checkout stand.

25. The network of claim 19 wherein:
the computerized network is integrated with one or more real-time or non-real-time networks selected from a group consisting essentially of an ATM network, credit card network, debit card network, stored value card network, wire transfer network, check clearing network, automatic clearing house, Internet, telephone network, data network, check cashing network, parking payment network, utility company network, coin exchange network, money services network, retail network, brokerage network, commodity network, insurance network, payment network, financial network, and merchant network.

26. A computerized network for performing a fund transfer transaction from a sender to a recipient, comprising:
a terminal connected to the network and accessible to the sender, the terminal including:
a reader that reads embedded identification information from an official identification document submitted by the sender, the embedded identification information, which is used to identify the sender, including an official identification document number, and at least one of a country and state that issued the official identification document, and
a user input device that receives recipient identification information and other transactional details for the fund transfer transaction; and
a computer system connected to the network for assigning a transaction identification number to the fund transfer transaction and for storing into a database the transaction identification number, sender identity information, the recipient identification information and the other transactional details, the transaction identification number including an identification of the computer system; the computer system using the transaction identification number provided by a claimant to retrieve the recipient identification information and the other transactional details associated with the transaction identification number, and authorizing delivery of payment to the claimant in accordance with the retrieved transactional details when claimant identification information corresponds to the retrieved recipient identification information.

27. A computerized network for performing a fund transfer transaction from a sender to a recipient, comprising:
a terminal connected to the network and accessible to a claimant, the terminal including:
a reader that reads second embedded identification information, which is used to verify an identity of the claimant, from an official identification document submitted by the claimant, and
a user input device that receives a transaction identification number identifying a computer system that assigned the transaction identification number and stored the transaction identification number, recipient identification information, other transactional details, and a sender identity obtained from first embedded identification information of an official identification document submitted by the sender, the first embedded identification information including an official identification document number, and at least one of a country and state that issued the official identification document; and
a network switch that connects the network with the terminal to a network of the computer system and routes a payment request from the terminal to the computer system based on the transaction identification number,
wherein the computer system uses the transaction identification number provided by the claimant to retrieve the recipient identification information and the other transactional details associated with the transaction identification number, and authorizes delivery of payment to the claimant in accordance with the retrieved transactional details when claimant identification information corresponds to the retrieved recipient identification information.

28. A terminal for performing a fund transfer transaction from a sender to a recipient through a computerized network, comprising:
a first input device that receives embedded identification information from an official identification document submitted by the sender, the embedded identification information, which is used to identify the sender, including an official identification document number, and at least one of a country and state that issued the official identification document;
a second input device that receives recipient identification information and other transactional details for the fund transfer transaction from the sender; and
a network connection device that connects the terminal through a network to a computer system that assigns a transaction identification number and stores the transaction identification number, a sender identity, the recipient identification information and the other transaction details into a database so the computer system is able to use the transaction identification number when provided by a claimant to retrieve the recipient identification information and the other transactional details associated with the transaction identification number, and to authorize delivery of payment to the claimant in accordance with the retrieved transactional details when claimant identification information corresponds to the retrieved recipient identification information.

29. The terminal of claim 28 in which the first input device and the second input device are integrated into a single device.

30. A terminal for performing a fund transfer transaction from a sender to a recipient through a computerized network, comprising:
a first input device that receives second embedded identification information, which is used to verify an identity of the claimant, from an official identification document submitted by a claimant;
a second input device that receives a transaction identification number identifying a computer system which assigned the transaction identification number and stored the transaction identification number, recipient identification information, other transactional details and a sender identity obtained from first embedded identification information of an official identification document submitted by the sender, the first embedded identification information including an official identification document number, and at least one of a country and state that issued the official identification document; and
a network connection device that connects the terminal through a network to the computer system so that the computer system is able to use the transaction identification number provided by the claimant to retrieve the recipient identification information and the other transactional details associated with the transaction identification number, and to authorize delivery of payment to the claimant in accordance with the retrieved transactional details when claimant identification information corresponds to the retrieved recipient identification information.

31. The terminal of claim 30 in which the first input device and the second input device are integrated into a single device.

32. The method of claim 1 further comprising:
permitting an entity to open an account and to use the account to conduct at least one payment transaction with at least one of a user ID, password, personal identification number, account identification number, national identification number, tax identification number, Identification document number, and any official identification document.

33. The method of claim 32 in which the entity comprises one of an individual, an organization, and a legal entity.
